(19) United States
(12) Patent Application Publication
(10) Pub. No.: US 2024/0412494 A1
(43) Pub. Date: Dec. 12, 2024

(54) ONLINE ADAPTIVE MULTI-SENSOR FUSION

(71) Applicant: QUALCOMM Incorporated, San Diego, CA (US)

(72) Inventors: Balaji Shankar Balachandran, San Diego, CA (US); Varun Ravi Kumar, San Diego, CA (US); Senthil Kumar Yogamani, Headford (IE)

(21) Appl. No.: 18/332,394

(22) Filed: Jun. 9, 2023

(51) Int. Cl. G06V 10/80; G01S 13/89; G01S 17/89

(52) U.S. Cl. CPC G06V 10/80; G01S 13/89; G01S 17/89

(57) ABSTRACT

This disclosure provides systems, methods, and devices that support image processing. In a first aspect, a method for multi-sensor fusion includes receiving first information indicative of a first set of BEV features of image data captured by an image sensor; receiving second information indicative of a second set of BEV features of non-image sensor data captured by a non-image sensor; and determining fused data that combines the image data and the non-image sensor data based on the first information, the second information, and third information indicative of differences between BEV features of training data and the first set of BEV features and the second set of BEV features. The BEV features of the training data include a third set of BEV features associated with the image sensor and a fourth set of BEV features associated with the non-image sensor. Other aspects and features are also claimed and described.

### TECHNICAL FIELD

Aspects of the present disclosure relate generally to multi-sensor fusion models, and more particularly, to methods and systems for online multi-sensor fusion model adaptation to reduce the effect of covariate shift.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

Data can be captured by multiple sensors of one of these driving assistance systems and then fused for various functions of the driving assistance system, such as 3D object detection. In some instances, data captured in a live environment may differ from data on which the driving assistance system was trained due to sensor degradation or other factors, which is detrimental to the driving assistance system's accuracy. Example embodiments provide techniques that support online adaptation of a multi-sensor fusion model to reduce the effect of covariate shift. The techniques address covariant shift in a statistically-driven online approach that adapts the multi-sensor fusion model to new unseen test data so that the multi-sensor fusion model maintains a suitable performance level for the new unseen test data as compared to the testing data. The multi-sensor fusion model identifies anomalies between covariance of training data and covariance of test data to identify covariate shift between the training data and test data (e.g., due to sensor degradation). The techniques additionally include domain descriptor heads that output values for each of the sensor modalities. The output values are compared to domain descriptor values in the training data for each sensor modality to determine how much covariate shift is present for each sensor modality.

Based on the identified covariate shift of the sensors as a whole and the determination of how much covariate shift is present for each sensor modality, the present techniques involve sampling the test data to determine which of the BEV features of each of the sensor modalities to modify and to determine values used to modify such BEV features. The test time BEV features of each of the sensor modalities are then fused with the determined modification values to generate fused data. In this way, 3D object detection performance is improved because the inference time performance of the multi-sensor fusion model is improved.

In one aspect of the disclosure, a method for multi-sensor fusion includes receiving first information indicative of a first set of BEV features of image data captured by an image sensor; receiving second information indicative of a second set of BEV features of non-image sensor data captured by a non-image sensor; and determining fused data that combines the image data and the non-image sensor data based on the first information, the second information, and third information indicative of differences between BEV features of training data and the first set of BEV features and the second set of BEV features. The BEV features of the training data include a third set of BEV features associated with the image sensor and a fourth set of BEV features associated with the non-image sensor.

In an additional aspect of the disclosure, an apparatus includes at least one processor and a memory coupled to the at least one processor. The at least one processor is configured to perform operations including receiving first information indicative of a first set of BEV features of image data captured by an image sensor; receiving second information indicative of a second set of BEV features of non-image sensor data captured by a non-image sensor; and determining fused data that combines the image data and the non-image sensor data based on the first information, the second information, and third information indicative of differences between BEV features of training data and the first set of BEV features and the second set of BEV features. The BEV features of the training data include a third set of BEV features associated with the image sensor and a fourth set of BEV features associated with the non-image sensor.

In an additional aspect of the disclosure, a method for training a model for multi-sensor fusion includes receiving first information indicative of a first set BEV features of image data, receiving second information indicative of a second set of BEV features of non-image sensor data, and determining third information indicative of differences between a third set of BEV features and a fourth set of BEV features. The third set of BEV features includes a first plurality of BEV features of the first set of BEV features and a second plurality of BEV features of the second set of BEV features, and the fourth set of BEV features includes a third plurality of BEV features of the first set of BEV features and a fourth plurality of BEV features of the second set of BEV features. The method further includes determining fused data that combines the image data and the non-image sensor data based on the first information, the second information, and the third information.

In an additional aspect of the disclosure, an apparatus includes at least one processor and a memory coupled to the at least one processor. The at least one processor is configured to perform operations including receiving first information indicative of a first set BEV features of image data, receiving second information indicative of a second set of BEV features of non-image sensor data, and determining third information indicative of differences between a third set of BEV features and a fourth set of BEV features. The third set of BEV features includes a first plurality of BEV features of the first set of BEV features and a second plurality of BEV features of the second set of BEV features, and the fourth set of BEV features includes a third plurality of BEV features of the first set of BEV features and a fourth plurality of BEV features of the second set of BEV features. The operations further include determining fused data that combines the image data and the non-image sensor data based on the first information, the second information, and the third information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1. 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4A is a block diagram of a computing device for adapting extracted BEV features of sensor data to improve multi-sensor fusion according to one or more aspects of the disclosure.

FIG. 4B is a block diagram illustrating a flow diagram of an architecture for a fusion model of the system of FIG. 4A for adapting sensor data prior to multi-sensor fusion according to one or more aspects of the disclosure.

FIG. 5 is a flow chart illustrating an example method for adapting and fusing data captured by multiple sensors of different modalities according to one or more aspects of the disclosure.

FIG. 6 is a flow chart illustrating an example method for training a model to adapt and fuse data captured by multiple sensors of different modalities according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support online adaptation of a multi-sensor fusion model to reduce the effect of covariate shift. Typically, test data input into a model at the inference stage is close to training data used to train the model at the training stage, but this is not always the case. Covariate shift occurs when the distribution of input sensor data to the multi-sensor fusion model shifts between the training environment and the inference environment, and in some instances the test data can vary significantly from the training data. The data distribution shift between the training environment and the inference environment can occur for a variety of reasons. For example, training labels (e.g., an object) may be the same in both training data and test data, but training data types (e.g., background of the scene including the object) are different. In another example, a sensor's physical components may wear over time which degrades the data quality output by the sensor over time such that the sensor data quality at test time differs from the sensor data quality the multi-sensor fusion model was trained on. Additionally, a multi-sensor fusion model may exhibit catastrophic forgetting when test data is input into the model, which is a tendency of a model to abruptly and drastically forget previously learned information upon learning new information.

The present techniques address covariant shifts in a statistically-driven online approach that adapts the multi-sensor fusion model to new unseen test data so that the multi-sensor fusion model maintains a suitable performance level for the new unseen test data as compared to the training data. To do so, the techniques involve training a multi-sensor fusion model to learn the codependence of bird's eye view (BEV) features of different sensor modalities, e.g., how variance of BEV features in one sensor modality affects the BEV features of another sensor modality. Stated differently, based on the present techniques, the multi-sensor fusion model learns how a covariate shift happens similarly across the different modalities on which the multi-sensor fusion model is trained. Based on this training, the multi-sensor fusion model identifies anomalies between covariance of training data and covariance of test data to identify covariate shift between the training data and test data (e.g., due to sensor degradation). The present techniques additionally include domain descriptor heads that output values for each of the sensor modalities. The output values are compared to domain descriptor values in the training data for each sensor modality to determine how much covariate shift is present for each sensor modality.

Based on the identified covariate shift of the sensors as a whole and the determination of how much covariate shift is present for each sensor modality, the present techniques involve sampling the test data to determine which of the BEV features of each of the sensor modalities to modify and to determine values used to modify such BEV features. Samples of the test data are mined to improve model performance and enhance the model's robustness against catastrophic forgetting. The test BEV features of each of the sensor modalities are then fused with the determined modification values to generate fused data. In this way, 3D object detection performance is improved because the inference time performance of the multi-sensor fusion model is improved.

Particular implementations of the subject matter described in this disclosure may be implemented to realize one or more of the following potential advantages or benefits. In some aspects, the present disclosure provides techniques for multi-sensor data processing that may be particularly beneficial in smart vehicle applications. For example, the techniques improve vehicle safety by providing a multi-sensor fusion model that adapts in an online manner to changes in test sensor data relative to training sensor data. In some aspects, the present techniques improve multi-sensor fusion model performance in out-of-distribution cases as domain-aware learning is considered. In various aspects, 3D object detection performance of a driving assistance system is improved over time as the multi-fusion model is trained with online test data, thereby improving the multi-fusion model's inference time performance.

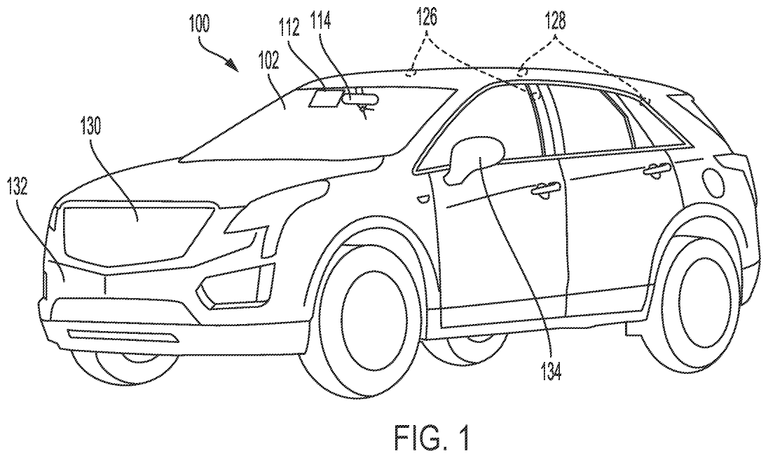

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

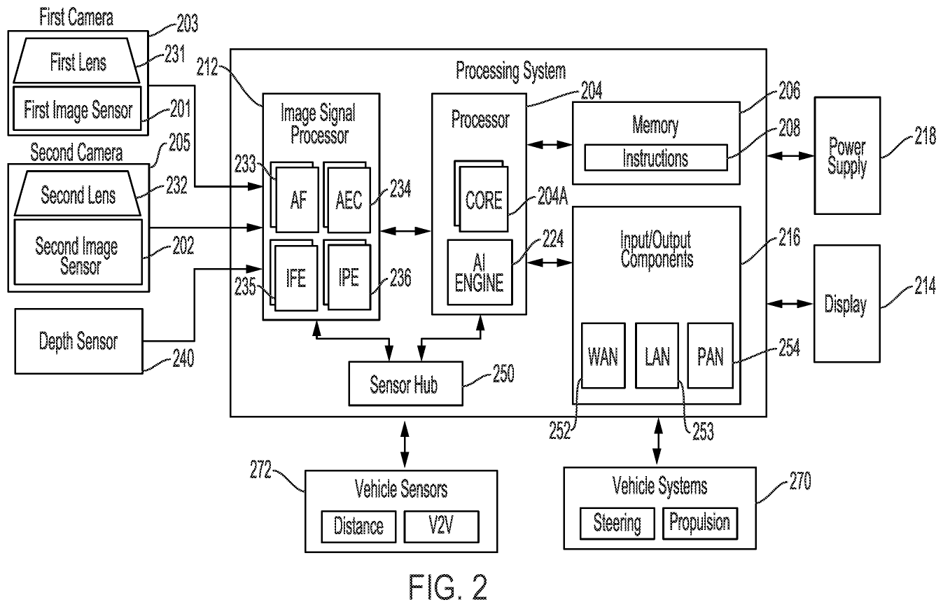

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

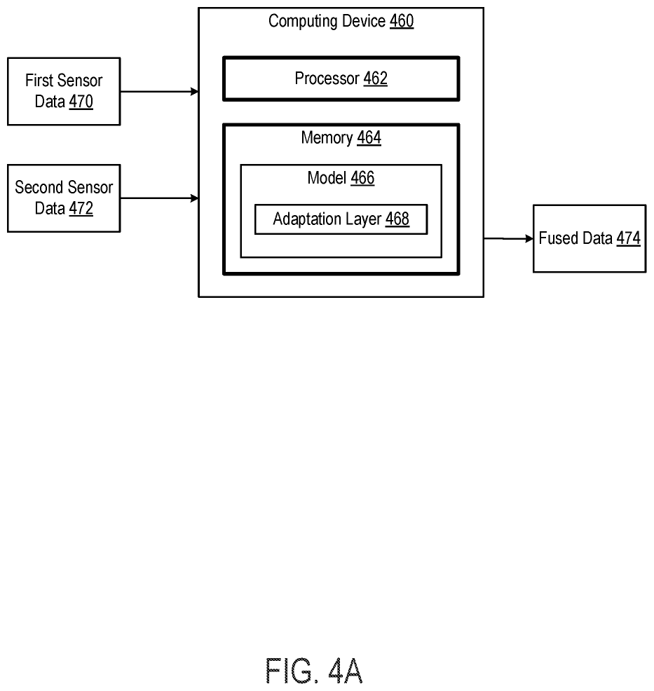

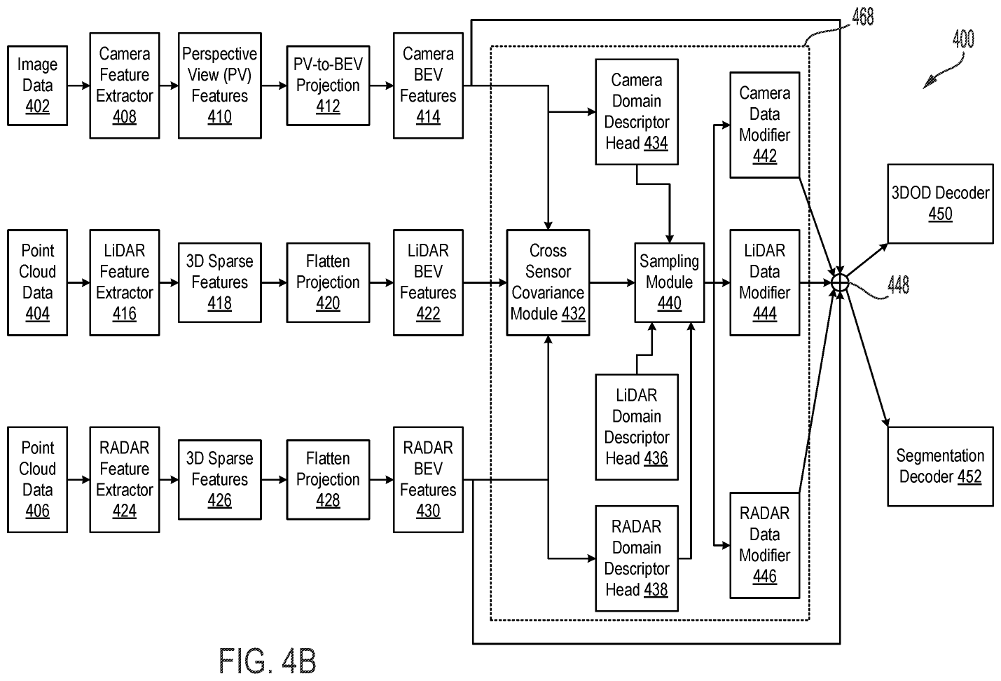

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination). The accuracy of the output of commands to the vehicle systems 270 may be improved according to embodiments of this disclosure by using one or more machine learning models, such as that described in connection with FIGS. 4-6, to adapt test time sensor data in order to reduce the effects of covariate shift that can affect the commands sent to the vehicle systems 270.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

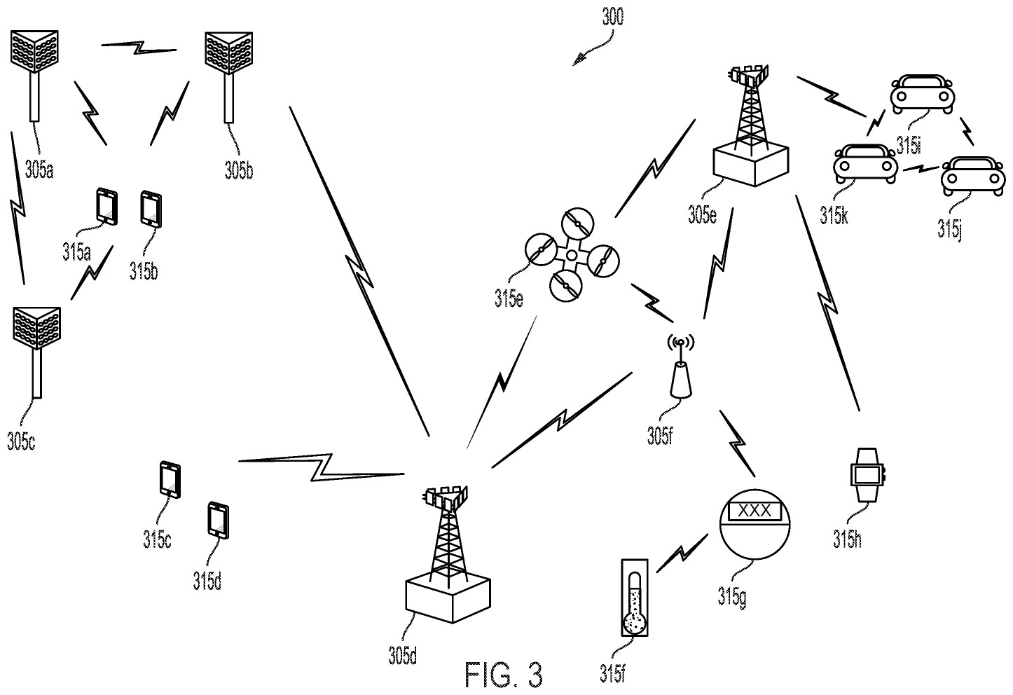

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage arca, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315c-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315c include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305c, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305c.

Aspects of the vehicular systems described with reference to, and shown in, FIG. 1, FIG. 2, and FIG. 3 may include techniques that support online adaptation of a multi-sensor fusion model to reduce the effect of covariate shift. The multi-sensor fusion model is trained to fuse data captured by two or more sensor modalities, such as image sensors, LiDAR sensors, and/or RADAR sensors. The techniques involve adapting the sensor data for fusion based on differences between BEV features of test data and BEV features of training data and on a magnitude of such differences. Stated differently, the techniques involve identifying whether covariate shift is present, identifying the data of which sensors of the multi-sensor system requires modification, and determining how much modification the data requires.

FIG. 4A is a block diagram of a computing device 460 for adapting extracted BEV features of sensor data online to improve multi-sensor fusion. Computing device 460 includes a processor 462 in communication with a memory 464. Memory 464 stores a model 466 configured to perform multi-sensor fusion. Model 466 includes a new and innovative adaptation layer 468 among other layers. Adaptation layer 468 modifies sensor data from each of two or more sensors prior to fusion to reduce the effects of covariate shift on the fused data. First sensor data 470 (e.g., image data) and second sensor data 472 (e.g., point cloud data) can be input into model 466, and one or both of first sensor data 470 and second sensor data 472 may exhibit covariate shift with respect to the sensor data on which model 466 was trained. Despite the covariate shift, model 466 outputs fused data 474 that reduces or eliminates the effect of the covariate shift on the fused data 474 that would have otherwise occurred without the adaptation layer 468. Computing device 460 may be implemented by the image processing configuration of FIG. 2 or by one or more of the components illustrated in FIG. 3. While model 466 is shown stored in memory 464 of computing device 460, in other examples, model 466 may be stored on a separate computing device (e.g., a server) in communication with computing device 460 over a network.

Model 466 may be implemented as one or more machine learning models, including supervised learning models, unsupervised learning models, other types of machine learning models, and/or other types of predictive models. For example, the model 466 may be implemented as one or more of a neural network, a transformer model, a decision tree model, a support vector machine, a Bayesian network, a classifier model, a regression model, and the like. The model 466 may be trained based on training data to fuse sensor data from multiple modalities. In particular, the adaptation layer 468 of model 466 may be trained based on training data to identify covariate shift in online test data and modify the online test data to reduce the effect of the covariate shift on the output fused data. For example, one or more training datasets may be used to train the adaptation layer 468 that contain extracted BEV features of sensor data from two or more sensor modalities. The training data sets may specify one or more expected outputs. For example, an expected output may be fused data generated from BEV features that do not demonstrate covariate shift. Parameters of the model 466 may be updated based on whether the model 466 generates correct outputs when compared to the expected outputs. In particular, the model 466 may receive one or more pieces of input data from the training data sets that are associated with a plurality of expected outputs. The model 466 may generate predicted outputs based on a current configuration of the model 466 The predicted outputs may be compared to the expected outputs and one or more parameter updates may be computed based on differences between the predicted outputs and the expected outputs. In particular, the parameters may include weights (e.g., priorities) for different features and combinations of features (e.g., spatial, dimensional, or other features of the extracted BEV features). The parameter updates to the model 466 may include updating one or more of the features analyzed and/or the weights assigned to different features or combinations of features (e.g., relative to the current configuration of the model 466).

FIG. 4B is a block diagram illustrating a flow diagram of an example model architecture 400 of model 466 for adapting sensor data prior to multi-sensor fusion. The example model architecture 400 is designed for multi-sensor fusion of image data 402 captured by an image sensor (e.g., first image sensor 201 or second image sensor 202) of a camera, point cloud data 404 captured by a LiDAR sensor (e.g., depth sensor 240), and point cloud data 406 captured by a RADAR sensor (e.g., depth sensor 240). In other examples, the model architecture 400 may be designed for fusion of only image data 402 and LiDAR point cloud data 404 (i.e. blocks 406, 424-430, 438, and 446 associated with RADAR are excluded), or of only image data 402 and RADAR point cloud data 406 (i.e. blocks 404, 416-422, 436, and 444 associated with LiDAR are excluded), or another combination of sensor data suited for multi-sensor fusion.

Model 466 includes an adaptation layer 468 that modifies one or more of image data 402, point cloud data 404, and point cloud data 406 prior to fusion to reduce the effects of covariate shift on the fused data. Adaptation layer 468 may be a layer of model 466, such as a sensor specific adaptation layer, or a separate model within the overall model 466. The blocks of model architecture 400 outside of adaptation layer 468 may each be typical components or processes of multi-sensor fusion models. For instance, at block 408 a camera feature extractor extracts perspective view (PV) features from image data 402, which are indicated at block 410. At block 412, the PV features are projected into the bird's eye view (BEV) plane. Camera BEV features 414 are then extracted from the BEV projection. At block 416, a LiDAR feature extractor extracts 3D sparse features from point cloud data 404, which are indicated at block 418. At block 420, the 3D sparse features are flattened into the BEV plane. LiDAR BEV features 422 are then extracted from the flattened 3D sparse features. At block 424, a RADAR feature extractor extracts 3D sparse features from point cloud data 406, which are indicated at block 426. At block 428, the 3D sparse features are flattened into the BEV plane. RADAR BEV features 430 are then extracted from the flattened 3D sparse features. The components and processing for performing the typical operations of blocks 408-430 are known to a person having ordinary skill in the art.

Adaptation layer 468 receives as input the camera BEV features 414, LiDAR BEV features 422, and RADAR BEV features 430. Each of the camera BEV features 414, LiDAR BEV features 422, and RADAR BEV features 430 are input into a cross sensor covariance module 432 of adaptation layer 468. Cross sensor covariance module 432 determines one or more values indicative of one or more differences between a covariance of camera BEV features 414, LiDAR BEV features 422, and RADAR BEV features 430 and a covariance of the camera BEV features, LiDAR BEV features, and RADAR BEV features on which adaptation layer 468 was trained.

During the training stage, cross sensor covariance module 432 of adaptation layer 468 is trained, in this example, with training data that includes BEV features of camera image sensor data, LiDAR sensor data, and RADAR sensor data to learn the codependence of the BEV features of the camera image sensor data, LiDAR sensor data, and RADAR sensor data. The learned codependence is indicative of how variance of BEV features of sensor data of one modality (e.g., camera image sensor) affects the BEV features of sensor data of another sensor modality (e.g., LiDAR sensor or RADAR sensor). To do so, in various embodiments, cross sensor covariance module 432 generates, from the training data, a matrix of values representing a covariance of a plurality of pairs of BEV features in the training data. Each pair of BEV features includes a BEV feature of sensor data of one modality (e.g., camera image sensor) and a BEV feature of sensor data of a different modality (e.g., LiDAR sensor or RADAR sensor). In this way, cross sensor covariance module 432 is trained to identify how a covariate shift happens similarly across the different sensor modalities. Stated differently, cross sensor covariance module 432 is trained to detect covariance of the sensor data of the different modalities in the training data as a whole. The matrix of values generated from the training data in this embodiment serves as a baseline from which the trained cross sensor covariance module 432 can determine if covariate shift is present in test data at the inference stage.

At the inference stage, the trained cross sensor covariance module 432 determines a matrix of values representing a covariance of a plurality of pairs of BEV features across the camera BEV features 414, LiDAR BEV features 422, and RADAR BEV features 430. The trained cross sensor covariance module 432 may compare the matrix of values determined at the inference stage with the matrix of values determined at the training stage to identify anomalies between the covariance of the training data and the covariance of the test data at the inference stage, which are indicative of covariate shift between the training data and test data (e.g., due to sensor degradation). Stated differently, the trained cross sensor covariance module 432 outputs values representative of differences between the values of the matrix determined at the inference stage and the values of the matrix determined at the training stage. The values representing the differences are indicative of whether the camera BEV features 414, LiDAR BEV features 422, and RADAR BEV features 430 are covarying differently than the camera BEV features, LiDAR BEV features, and RADAR BEV features on which cross sensor covariance module 432 was trained, which can indicate covariate shift.

Each of the camera BEV features 414, LiDAR BEV features 422, and RADAR BEV features 430 are further input into respective domain descriptor heads that process domain shift between the camera BEV features 414, LiDAR BEV features 422, and RADAR BEV features 430 and the camera BEV features, LiDAR BEV features, and RADAR BEV features on which adaptation model 468 was trained. The domain descriptor heads output values indicative of how much the BEV features of each sensor modality are varying individually from the BEV features of each sensor modality on which the domain descriptor heads were trained. More specifically, camera BEV features 414 may be input into camera domain descriptor head 434, LiDAR BEV features 422 may be input into LiDAR domain descriptor head 436 (arrow not illustrated in FIG. 4B for clarity in the figure), and RADAR BEV features 430 may be input into RADAR domain descriptor head 438. Camera domain descriptor head 434 outputs at least one value (e.g., domain descriptor value) indicative of a magnitude of variance of the camera BEV features 414 from the camera BEV features on which camera domain descriptor head 434 was trained. LiDAR domain descriptor head 436 outputs at least one value (e.g., domain descriptor value) indicative of a magnitude of variance of the LiDAR BEV features 422 from the LIDAR BEV features on which LiDAR domain descriptor head 436 was trained. RADAR domain descriptor head 438 outputs at least one value (e.g., domain descriptor value) indicative of a magnitude of variance of the RADAR BEV features 430 from the RADAR features on which RADAR domain descriptor head 438 was trained.

During the training stage, adaptation layer 468 of model 466 is trained with training data that includes domain descriptor values for each camera BEV feature in the training data, for each LiDAR BEV feature in the training data, and for each RADAR BEV feature in the training data. The domain descriptor values may be obtained by computing the camera BEV features and LiDAR BEV features offline and creating feature vectors. In this way, the domain descriptor values for each camera BEV feature in the training data is known to camera domain descriptor head 434. Similarly, the domain descriptor values for each LiDAR BEV feature in the training data is known to LiDAR domain descriptor head 436. Similarly, the domain descriptor values for each RADAR BEV feature in the training data is known to RADAR domain descriptor head 438.

At the inference stage, camera domain descriptor head 434 determines domain descriptor values of camera BEV features 414. The camera domain descriptor head 434 then compares the domain descriptor values determined at the inference stage for the camera modality with the domain descriptor values of the training stage for the camera modality. Based on the comparison, camera domain descriptor head 434 outputs at least one value indicative of one or more differences between the domain descriptor values determined at the inference stage for the camera modality with the domain descriptor values of the training stage for the camera modality. The output value(s) from camera domain descriptor head 434 are indicative of, or can be used to determine, whether covariate shift is present for the camera modality individually, and if covariate shift is present, a magnitude of the covariate shift.

Similarly, LiDAR domain descriptor head 436 determines domain descriptor values of LiDAR BEV features 422. The LiDAR domain descriptor head 436 then compares the domain descriptor values determined at the inference stage for the LiDAR modality with the domain descriptor values of the training stage for the LiDAR modality. Based on the comparison, LiDAR domain descriptor head 436 outputs at least one value indicative of one or more differences between the domain descriptor values determined at the inference stage for the LiDAR modality with the domain descriptor values of the training stage for the LiDAR modality. The output value(s) from LiDAR domain descriptor head 436 are indicative of, or can be used to determine, whether covariate shift is present for the LiDAR modality individually, and if covariate shift is present, a magnitude of the covariate shift.

Similarly, RADAR domain descriptor head 438 determines domain descriptor values of RADAR BEV features 430. The RADAR domain descriptor head 438 then compares the domain descriptor values determined at the inference stage for the RADAR modality with the domain descriptor values of the training stage for the RADAR modality. Based on the comparison, RADAR domain descriptor head 438 outputs at least one value indicative of one or more differences between the domain descriptor values determined at the inference stage for the RADAR modality with the domain descriptor values of the training stage for the RADAR modality. The output value(s) from RADAR domain descriptor head 438 are indicative of, or can be used to determine, whether covariate shift is present for the RADAR modality individually, and if covariate shift is present, a magnitude of the covariate shift.

Based on the outputs of cross sensor covariance module 432 and each of the camera domain descriptor head 434, LiDAR domain descriptor head 436, and RADAR domain descriptor head 438, a sampling module 440 of adaptation layer 468 identifies online samples of the camera BEV features 414, LiDAR BEV features 422, and RADAR BEV features 430 that require modification prior to fusion to reduce the effect of covariate shift. For example, sampling module 440 may determine one or more values for modifying camera BEV features 414 that are associated with an output value from the camera domain descriptor head 434 that is indicative of covariate shift (e.g., the output value meets a predetermined threshold). Sampling module 440 may similarly identify LiDAR BEV features 422 and/or RADAR BEV features 430 that are associated with such output values from the LiDAR domain descriptor head 436 or RADAR domain descriptor head 438, respectively.

During the training stage of sampling module 440, the training data is sampled to identify samples of varying difficulty level (e.g., easy, medium, hard) for sampling module 440. For example, hard samples for the camera modality may be associated with an output value from the camera domain descriptor head 434 that fails to meet a first threshold. Stated differently, hard samples are associated with output values indicative of small differences between domain descriptor values of camera BEV features 414 and domain descriptor values of the camera BEV features on which sampling module 440 was trained. The small differences of the hard samples can be more difficult for sampling module 440 to decipher as covariate shift at the inference stage. Training adaptation layer 468 on the hard samples improves the performance of adaptation layer 468 to detect small differences in descriptor values, that are indicative of covariate shift, of new unseen data at the inference stage.

In another example, medium samples for the camera modality may be associated with an output value from the camera domain descriptor head 434 that meets the first threshold but fails to meet a second threshold greater than the first threshold. In another example, easy samples for the camera modality may be associated with an output value from the camera domain descriptor head 434 that meets the second threshold. Stated differently, medium samples are associated with output values indicative of medium differences, and easy samples of large differences, between domain descriptor values of camera BEV features 414 and domain descriptor values of the camera BEV features on which adaptation layer 468 was trained. The adaptation layer 468 performs well at identifying covariate shift at the inference stage for the medium and large differences of the medium and easy samples. However, as adaptation layer 468 learns new information, adaptation layer 468 may be subject to catastrophic forgetting, which is the tendency of model (e.g., neural network) to abruptly and drastically forget previously learned information upon learning new information. Training adaptation layer 468 on the medium and easy samples improves the robustness of adaptation layer 468 against catastrophic forgetting when input new unseen data at the inference stage. Based on this training of sampling module 440, adaptation layer 468 is able to adapt model 466 to new, difficult test data and at the same time perform well for less difficult, new test data for which adaptation layer 468 is expected to perform well.

At the inference stage, the output values from the cross sensor covariance module 432 and the output values of each of the camera domain descriptor head 434, LiDAR domain descriptor head 436, and RADAR domain descriptor head 438 are input to sampling module 440. From these values, sampling module 440 identifies which of the values are indicative of covariate shift and what BEV features those values are associated with. For each of the camera BEV features 414, LiDAR BEV features 422, and RADAR BEV features 430 that are associated with values indicative of covariate shift, sampling module 440 determines and outputs one or more modifier values for modifying the camera BEV features 414, LiDAR BEV features 422, and/or RADAR BEV features 430. Specifically, sampling module 440 may output one or more camera data modifiers 442 for modifying camera BEV features 414, one or more LiDAR data modifiers 444 for modifying LiDAR BEV features 422, and/or one or more RADAR data modifiers 446 for modifying RADAR BEV features 430. For example, sampling module 440 receives as input the matrix of values output by cross sensor covariance module 432 and domain descriptor values from each of the camera domain descriptor head 434, LiDAR domain descriptor head 436, and RADAR domain descriptor head 438. Each input value to sampling module 440 is associated with a learnable weight. Adaptation layer 468 learns to subtract sensor values based on the learnable weights from the sampling module 440 to generate the one or more camera data modifiers 442, one or more LiDAR data modifiers 444, and/or one or more RADAR data modifiers that compensate for sensor-specific degradation.

Each of the camera data modifiers 442, LiDAR data modifiers 444, and RADAR data modifiers 446 are value(s) in the same space as the camera BEV features 414, LiDAR BEV features 422, and RADAR BEV features 430 such that the camera BEV features 414, LIDAR BEV features 422, and RADAR BEV features 430 can be modified with the respective camera data modifiers 442, LiDAR data modifiers 444, and RADAR data modifiers 446. For example, each of the camera data modifiers 442, LiDAR data modifiers 444, and RADAR data modifiers 446 may be adapted coordinates or the like for the respective camera BEV features 414, LiDAR BEV features 422, and RADAR BEV features 430. Each of the camera BEV features 414, LiDAR BEV features 422, and RADAR BEV features 430 are modified to what each would be without the factors (e.g., sensor degradation) that result in covariate shift.

Each of the camera data modifiers 442, LiDAR data modifiers 444, and RADAR data modifiers 446 are then input into a typical sensor fusion block 448 along with the camera BEV features 414, LiDAR BEV features 422 (arrow not shown in FIG. 4B for clarity in the figure), and RADAR BEV features 430. The camera data modifiers 442, LiDAR data modifiers 444, and RADAR data modifiers 446 modify the camera BEV features 414, LIDAR BEV features 422, and RADAR BEV features 430 such that the effects of covariate shift are reduced or eliminated in the fused data output from the sensor fusion block 448. For example, the camera data modifiers 442, LiDAR data modifiers 444, and RADAR data modifiers 446 are respectively added to the camera BEV features 414, LiDAR BEV features 422, and RADAR BEV features 430. The output fused data can be input, in various embodiments, into a typical 3D object detection (3DOD) decoder 450 and a typical segmentation decoder 452. In this way, the performance of model 466 in generating multi-sensor fused data that is accurate with respect to a scene in view of the multiple sensors is improved by improving the inference time performance of model 466 through the addition of the adaptation layer 468.

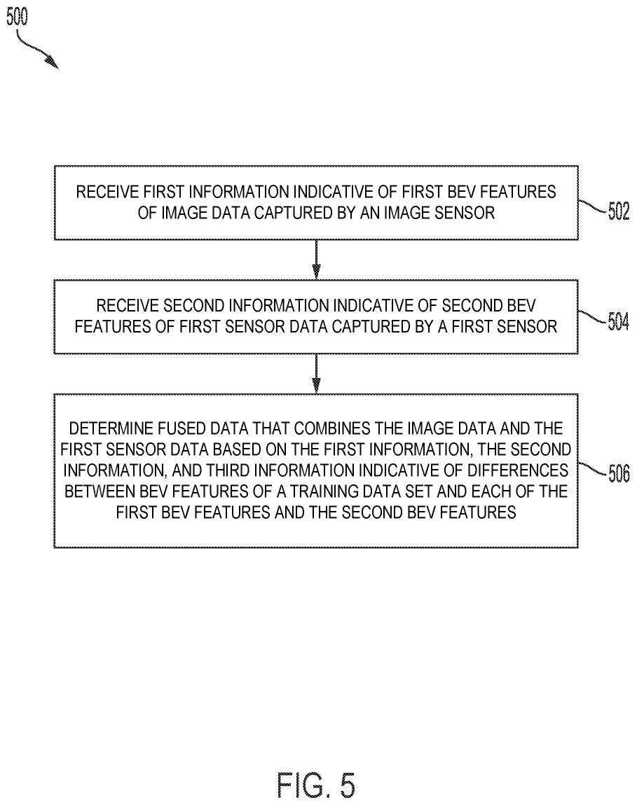

One method of performing image processing according to embodiments described above is shown in FIG. 5. FIG. 5 is a flow chart illustrating an example method for adapting and fusing data captured by multiple sensors of different modalities. A method 500 includes, at block 502, receiving (e.g., by adaptation layer 468 of model 466) first information indicative of first BEV features (e.g., camera BEV features 414) of image data (e.g., image data 402) captured by an image sensor. The image sensor may be a component of a camera, such as a camera disposed on a vehicle.

At block 504, method 500 includes receiving (e.g., by adaptation layer 468 of model 466) second information indicative of second BEV features (e.g., LiDAR BEV features 422 or RADAR BEV features 430) of first sensor data (e.g., point cloud data 404 or point cloud data 406) captured by a first sensor. In some embodiments, the first sensor is a LiDAR sensor and the first sensor data is point cloud data 404. In other embodiments, the first sensor is a RADAR sensor and the first sensor data is point cloud data 406.

In various embodiments, method 500 may further include receiving (e.g., by adaptation layer 468 of model 466) fourth information indicative of third BEV features (e.g., RADAR BEV features 430 or LiDAR BEV features 422) of second sensor data (e.g., point cloud data 406 or point cloud data 404) captured by a second sensor. In some embodiments, the second sensor is a RADAR sensor and the second sensor data is point cloud data 406. For example, in such embodiments (e.g., FIG. 4B), method 500 may include receiving information indicative of BEV features of each of image sensor data, LiDAR sensor data, and RADAR sensor data. In other embodiments, the second sensor is a LIDAR sensor and the second sensor data is point cloud data 404. For example, in such embodiments (e.g., FIG. 4B), method 500 may include receiving information indicative of BEV features of each of image sensor data, LiDAR sensor data, and RADAR sensor data.

At block 506, method 500 includes determining fused data that combines the image data and the first sensor data based on the first information, the second information, and third information indicative of differences between BEV features of training data and each of the first BEV features and the second BEV features. In an example, the third information is determined by adaptation layer 468 of model 466. The training data comprises a first set of BEV features associated with the image sensor and a second set of BEV features associated with the first sensor. The training data is generated from a fixed sensor setup including at least the image sensor and the first sensor. In embodiments in which method 500 includes receiving the fourth information, the third information is indicative of differences between BEV features of training data and each of the first BEV features, the second BEV features, and the third BEV features, and the training data further comprises a third set of BEV features associated with the second sensor. Additionally, the fused data combines the image data, the first sensor data, and the second sensor data based on the first information, the second information, the third information, and the fourth information.

In at least some implementations, the third information includes a first indication of a difference between a first matrix of values representing a covariance of the first BEV features and the second BEV features and a second matrix of values representing a covariance of the first set of BEV features and the second set of BEV features of the training data. For example, the cross sensor covariance module 432 may determine the first indication. In implementations including the second sensor, the first matrix of values represents a covariance of the first BEV features, the second BEV features, and the third BEV features, and the second matrix of values represents a covariance of the first set of BEV features, the second set of BEV features, and a third set of BEV features of the training data.

In at least some implementations, the training data comprises a first domain descriptor value associated with the image sensor and a second domain descriptor value associated with the first sensor. In such embodiments, the third information includes a second indication of a difference between the first domain descriptor value and a third domain descriptor value associated with the first BEV features, and a third indication of a difference between the second domain descriptor value and a fourth domain descriptor value associated with the second BEV features. For example, the camera domain descriptor head 434 may determine the third domain descriptor value associated with the camera BEV features 414 and determine the second indication of the difference between the first domain descriptor value of the training data and the third domain descriptor value. Additionally, the LiDAR domain descriptor head 436 (or the RADAR domain descriptor head 438) may determine the fourth domain descriptor value associated with the LiDAR BEV features 422 (or RADAR BEV features 430) and determine the second indication of the difference between the second domain descriptor value of the training data and the fourth domain descriptor value. In implementations including the second sensor, the RADAR domain descriptor head 438 additionally may determine a fifth domain descriptor value associated with the RADAR BEV features 430 and determine a third indication of the difference between a sixth domain descriptor value of the training data associated with the second sensor and the sixth domain descriptor value.

In at least some implementations, the differences between the BEV features of the training data and each of the first BEV features and the second BEV features are indicative of covariate shift between the first BEV features and the BEV features of the training data associated with the image data or between the second BEV features and the BEV features of the training data associated with the first sensor data, or both. For example, the first indication of a difference determined by the cross sensor covariance module 432 is indicative of covariate shift of the image sensor and first sensor as a whole. In another example, the second and third indications of differences are indicative of covariate shift of the image sensor and the first sensor individually. In another example, the sampling module 444 may determine camera data modifier 442, LiDAR data modifier 444, and RADAR data modifier 446. Each of these modifiers 442, 444, 446 are indicative of differences between the camera BEV features 414, LiDAR BEV features 422, and RADAR BEV features 430 and the camera BEV features, LiDAR BEV features, and RADAR BEV features included in the training data, which are indicative of covariate shift.

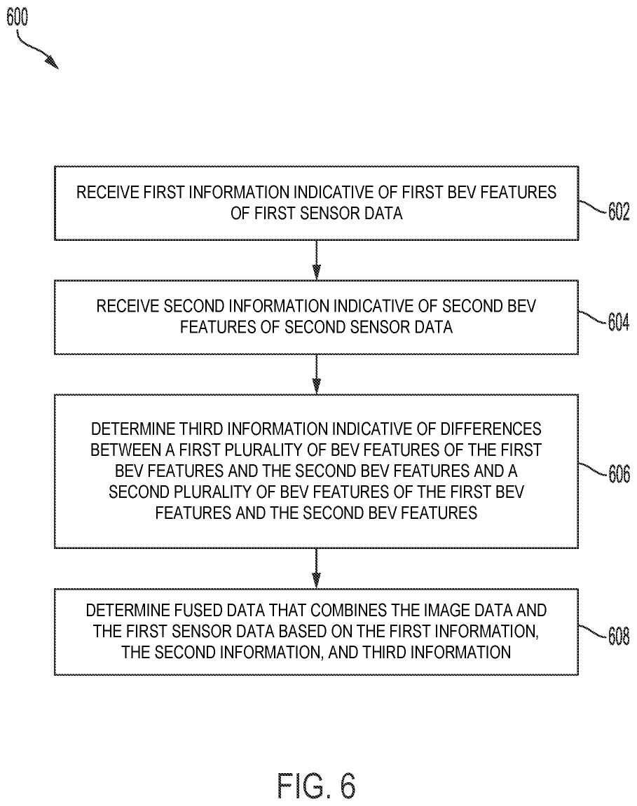

One method of training a model according to embodiments described above is shown in FIG. 6. FIG. 6 is a flow chart illustrating an example method for training a model to adapt and fuse data captured by multiple sensors of different modalities. Training data for training the model is generated from a fixed sensor setup including two or more sensors of different modalities. A method 600 includes, at block 602, receiving (e.g., by adaptation layer 468 of model 466) first information indicative of first BEV features (e.g., camera BEV features 414) of first sensor data (e.g., image data 402). The first sensor data is captured by a first sensor. In some implementations, the first sensor may be an image sensor of a camera, such as a camera disposed on a vehicle.

At block 604, method 600 includes receiving (e.g., by adaptation layer 468 of model 466) second information indicative of second BEV features (e.g., LiDAR BEV features 422 or RADAR BEV features 430) of second sensor data (e.g., point cloud data 404 or point cloud data 406) captured by a second sensor. In some embodiments, the second sensor is a LiDAR sensor and the second sensor data is point cloud data 404. In other embodiments, the second sensor is a RADAR sensor and the second sensor data is point cloud data 406.

In various embodiments, method 600 may further include receiving (e.g., by adaptation layer 468 of model 466) fourth information indicative of third BEV features (e.g., RADAR BEV features 430 or LiDAR BEV features 422) of third sensor data (e.g., point cloud data 406 or point cloud data 404) captured by a third sensor. In some embodiments, the third sensor is a RADAR sensor and the third sensor data is point cloud data 406. For example, in such embodiments (e.g., FIG. 4B), method 600 may include receiving information indicative of BEV features of each of image sensor data, LiDAR sensor data, and RADAR sensor data. In other embodiments, the third sensor is a LiDAR sensor and the third sensor data is point cloud data 404. For example, in such embodiments (e.g., FIG. 4B), method 600 may include receiving information indicative of BEV features of each of image sensor data, LiDAR sensor data, and RADAR sensor data.

At block 606, method 600 includes determining third information (e.g., via adaptation layer 468 of model 466) indicative of differences between a first plurality of BEV features of the first BEV features and the second BEV features and a second plurality of BEV features of the first BEV features and the second BEV features. The training data comprises a first set of BEV features associated with the image sensor and a second set of BEV features associated with the first sensor. In embodiments in which method 500 includes receiving the fourth information, the third information is indicative of differences between BEV features of training data and each of the first BEV features, the second BEV features, and the third BEV features, and the training data further comprises a third set of BEV features associated with the second sensor. Additionally, the fused data combines the image data, the first sensor data, and the second sensor data based on the first information, the second information, the third information, and the fourth information.

In some implementations, determining the third information includes determining (e.g., via cross sensor covariance module 432) a matrix of values representing a covariance of a plurality of pairs of BEV features. Each pair of the plurality of pairs includes a BEV feature of the first BEV features and a BEV feature of the second BEV features. In such implementations, the third information is based on the matrix of values. In implementations including the third sensor, the matrix of values represents a covariance of the first BEV features, the second BEV features, and the third BEV features.

In some implementations, determining the third information includes determining a first plurality of domain descriptors associated with the first plurality of BEV features, determining a second plurality of domain descriptors associated with the second plurality of BEV features, and determining indications of differences between the first plurality of domain descriptors and the second plurality of domain descriptors. For example, camera domain descriptor head 434 may determine at least one indication of a difference between camera BEV features of the first plurality of BEV features and camera BEV features of the second plurality of BEV features. In another example, LiDAR domain descriptor head 436 (or RADAR domain descriptor head 438) may determine at least one indication of a difference between LiDAR (or RADAR) BEV features of the first plurality of BEV features and LiDAR (or RADAR) BEV features of the second plurality of BEV features. In such implementations, the third information is based on the indications of differences. In implementations including the third sensor, RADAR domain descriptor head 438 (or LiDAR domain descriptor head 436) additionally may determine at least one indication of a difference between RADAR (or LiDAR) BEV features of the second plurality of BEV features.

In some implementations, determining the third information includes determining (e.g., via sampling module 440) a first set of samples that include BEV features of the second plurality of BEV features. The BEV features of the first set of samples are associated with indications of differences that fail to meet a first threshold (e.g., hard samples). Determining the third information further includes determining (e.g., via sampling module 440) a second set of samples that include BEV features of the second plurality of BEV features. The BEV features of the second set of samples are associated with indications of differences that meet a second threshold (e.g., easy samples). The second threshold is greater than the first threshold. In implementations including the third sensor, the BEV features of the first and second set of samples include camera BEV features, LiDAR BEV features, and RADAR BEV features.

At block 608, method 600 includes determining fused data that combines the first sensor data and the second sensor data based on the first information, the second information, and third information. In some implementations, determining the fused data combines the first set of samples and the second set of samples. In implementations including the third sensor, determining the fused data combines the first sensor data, the second sensor data, and the third sensor data based on the first information, the second information, the third information, and the fourth information.

It is noted that one or more blocks (or operations) described with reference to FIGS. 5-6 may be combined with one or more blocks (or operations) described with reference to another of the figures. For example, one or more blocks (or operations) of FIG. 5 or FIG. 6 may be combined with one or more blocks (or operations) of FIG. 1-3. As another example, one or more blocks associated with FIG. 5 or FIG. 6 may be combined with one or more blocks associated with FIGS. 4A or 4B.

In one or more aspects, techniques for supporting vehicular operations may include additional aspects, such as any single aspect or any combination of aspects described below or in connection with one or more other processes or devices described elsewhere herein. In a first aspect, an apparatus includes a memory coupled to a processor that is configured to perform operations for multi-sensor fusion including receiving first information indicative of a first set of BEV features of image data captured by an image sensor; receiving second information indicative of a second set of BEV features of non-image sensor data captured by a non-image sensor; and determining fused data that combines the image data and the non-image sensor data based on the first information, the second information, and third information indicative of differences between BEV features of training data and the first set of BEV features, the second set of BEV features, or both. The BEV features of the training data include a third set of BEV features associated with the image sensor and a fourth set of BEV features associated with the non-image sensor. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the first non-image sensor is a LiDAR sensor and the first non-image sensor data is point cloud data.

In a third aspect, in combination with the first aspect, the first non-image sensor is a RADAR sensor and the first non-image sensor data is point cloud data.

In a fourth aspect, in combination with the first aspect, the processor is further configured to perform operations including receiving fourth information indicative of a fifth set of BEV features of second non-image sensor data captured by a second non-image sensor. The third information is indicative of differences between the BEV features of the training data and the first set of BEV features, the second set of BEV features, and the fifth set of BEV features. The BEV features of the training data further include a sixth set of BEV features associated with the second non-image sensor. And the fused data combines the image data, the first non-image sensor data, and the second non-image sensor data based on the first information, the second information, the third information, and the fourth information.

In a fifth aspect, in combination with the first aspect or the fourth aspect, the first non-image sensor is a LiDAR sensor, the second non-image sensor is a RADAR sensor, the first non-image sensor data is first point cloud data, and the second non-image sensor data is second point cloud data.

In a sixth aspect, in combination with one or more of the first aspect through the fifth aspect, the third information includes a first indication of a difference between a first matrix of values and a second matrix of values, the first matrix of values representing a covariance of the first set of BEV features and the second set of BEV features, and the second matrix of values representing a covariance of the third set of BEV features and the fourth set of BEV features of the training data.

In a seventh aspect, in combination with one or more of the first aspect through the sixth aspect, the training data includes a first domain descriptor value associated with the image sensor and a second domain descriptor value associated with the first non-image sensor. In the seventh aspect, the third information includes: a second indication of a difference between the first domain descriptor value and a third domain descriptor value associated with a first BEV feature of the first set of BEV features, and a third indication of a difference between the second domain descriptor value and a fourth domain descriptor value associated with a second BEV feature of the second set of BEV features.

In an eighth aspect, in combination with one or more of the first aspect through the seventh aspect, the differences between the BEV features of the training data and the first set of BEV features and the second set of BEV features are indicative of covariate shift between the first set of BEV features and the third set of BEV features, between the second set of BEV features and the fourth set of BEV features, or both.

In a ninth aspect, an apparatus includes a memory coupled to a processor that is configured to perform operations for training a model for multi-sensor fusion. The operations include receiving first information indicative of a first set BEV features of image data; receiving second information indicative of a second set of BEV features of non-image sensor data; determining third information indicative of differences between a third set of BEV features and a fourth set of BEV features. The third set of BEV features includes a first plurality of BEV features of the first set of BEV features and a second plurality of BEV features of the second set of BEV features, and the fourth set of BEV features includes a third plurality of BEV features of the first set of BEV features and a fourth plurality of BEV features of the second set of BEV features. The operations further include determining fused data that combines the image data and the non-image sensor data based on the first information, the second information, and the third information.

In a tenth aspect, in combination with one or more of the ninth aspect, the non-image sensor data is captured by either a LiDAR sensor or a RADAR sensor.

In an eleventh aspect, in combination with one or more of the ninth aspect through the tenth aspect, determining the third information includes determining a matrix of values representing a covariance of a plurality of pairs of BEV features. Each pair of the plurality of pairs includes a first BEV feature of the first set of BEV features and a second BEV feature of the second set of BEV features. In the eleventh aspect, the third information is based on the matrix of values.

In a twelfth aspect, in combination with one or more of the ninth aspect through the eleventh aspect, wherein determining the third information includes determining a first plurality of domain descriptors associated with the third set of BEV features; determining a second plurality of domain descriptors associated with the fourth set of BEV features; and determining indications of differences between the first plurality of domain descriptors and the second plurality of domain descriptors. In the twelfth aspect, the third information is based on the indications of differences.

In a thirteenth aspect, in combination with one or more of the ninth aspect through the twelfth aspect, determining the third information includes: determining a first set of samples that include a fifth set of BEV features of the fourth set of BEV features, and determining a second set of samples that include a sixth set of BEV features of the fourth set of BEV features. Each BEV feature of the fifth set of BEV features is associated with an indication of the indications of differences that fails to meet a first threshold, and each BEV feature of the sixth set of BEV features is associated with an indication of the indications of differences that meets a second threshold. The second threshold is greater than the first threshold. In the thirteenth aspect, determining the fused data is based on the first set of samples and the second set of samples.

In a fourteenth aspect, in combination with one or more of the ninth aspect through the thirteenth aspect, the operations further include receiving fourth information indicative of a fifth set of BEV features of second non-image sensor data. In the fourteenth aspect, the third set of BEV features includes the first plurality of BEV features of the first set of BEV features, the second plurality of BEV features of the second set of BEV features, and a fifth plurality of BEV features of the fifth set of BEV features. In the fourteenth aspect, the fourth set of BEV features includes the third plurality of BEV features of the first set of BEV features, the fourth plurality of BEV features of the second set of BEV features, and a sixth plurality of BEV features of the fifth set of BEV features. In the fourteenth aspect, the fused data combines the image data, the non-image sensor data, and the second non-image sensor data based on the first information, the second information, the third information, and the fourth information.

In a fifteenth aspect, in combination with the fourteenth aspect, the image data is captured by an image sensor of a camera, the non-image sensor data is captured by a LiDAR sensor, and the second non-image sensor data is captured by a RADAR sensor.

Components, the functional blocks, and the modules described herein with respect to FIGS. 1-4A and 4B include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for multi-sensor fusion, comprising:
receiving first information indicative of a first set of BEV features of image data captured by an image sensor;
receiving second information indicative of a second set of BEV features of first non-image sensor data captured by a first non-image sensor; and
determining fused data that combines the image data and the first non-image sensor data based on the first information, the second information, and third information indicative of differences between BEV features of training data and the first set of BEV features, the second set of BEV features, or both, the BEV features of the training data comprise a third set of BEV features associated with the image sensor and a fourth set of BEV features associated with the first non-image sensor.

2. The method of claim 1, wherein the first non-image sensor is a LiDAR sensor and the first non-image sensor data is point cloud data.

3. The method of claim 1, wherein the first non-image sensor is a RADAR sensor and the first non-image sensor data is point cloud data.

4. The method of claim 1, further comprising:
receiving fourth information indicative of a fifth set of BEV features of second non-image sensor data captured by a second non-image sensor, wherein:
the third information is indicative of differences between the BEV features of the training data and the first set of BEV features, the second set of BEV features, and the fifth set of BEV features,
the BEV features of the training data further comprise a sixth set of BEV features associated with the second non-image sensor, and
the fused data combines the image data, the first non-image sensor data, and the second non-image sensor data based on the first information, the second information, the third information, and the fourth information.

5. The method of claim 4, wherein:
the first non-image sensor is a LiDAR sensor;
the second non-image sensor is a RADAR sensor;
the first non-image sensor data is first point cloud data; and
the second non-image sensor data is second point cloud data.

6. The method of claim 1, wherein the third information comprises a first indication of a difference between a first matrix of values and a second matrix of values, the first matrix of values representing a covariance of the first set of BEV features and the second set of BEV features, the second matrix of values representing a covariance of the third set of BEV features and the fourth set of BEV features of the training data.

7. The method of claim 6, wherein the training data comprises a first domain descriptor value associated with the image sensor and a second domain descriptor value associated with the first non-image sensor, and wherein the third information comprises:
a second indication of a difference between the first domain descriptor value and a third domain descriptor value associated with a first BEV feature of the first set of BEV features, and
a third indication of a difference between the second domain descriptor value and a fourth domain descriptor value associated with a second BEV feature of the second set of BEV features.

8. The method of claim 7, wherein the differences between the BEV features of the training data and the first set of BEV features and the second set of BEV features are indicative of covariate shift between the first set of BEV features and the third set of BEV features, between the second set of BEV features and the fourth set of BEV features, or both.

9. An apparatus, comprising:
a memory storing processor-readable code; and
at least one processor coupled to the memory, the at least one processor configured to execute the processor-readable code to cause the at least one processor to perform operations including:
receiving first information indicative of a first set of BEV features of image data captured by an image sensor;
receiving second information indicative of a second set of BEV features of first non-image sensor data captured by a first non-image sensor; and
determining fused data that combines the image data and the first non-image sensor data based on the first information, the second information, and third information indicative of differences between BEV features of training data and the first set of BEV features, the second set of BEV features, or both, the BEV features of the training data comprise a third set of BEV features associated with the image sensor and a fourth set of BEV features associated with the first non-image sensor.

10. The apparatus of claim 9, wherein the first non-image sensor is a LiDAR sensor and the first non-image sensor data is point cloud data.

11. The apparatus of claim 9, wherein the first non-image sensor is a RADAR sensor and the first non-image sensor data is point cloud data.

12. The apparatus of claim 9, wherein the operations further include:
receiving fourth information indicative of a fifth set of BEV features of second non-image sensor data captured by a second non-image sensor, wherein:
the third information is indicative of differences between the BEV features of the training data and the first set of BEV features, the second set of BEV features, and the fifth set of BEV features,
the BEV features of the training data further comprise a sixth set of BEV features associated with the second non-image sensor, and
the fused data combines the image data, the first non-image sensor data, and the second non-image sensor data based on the first information, the second information, the third information, and the fourth information.

13. The apparatus of claim 12, wherein:
the first non-image sensor is a LiDAR sensor;
the second non-image sensor is a RADAR sensor;
the first non-image sensor data is first point cloud data; and
the second non-image sensor data is second point cloud data.

14. The apparatus of claim 9, wherein the third information comprises a first indication of a difference between a first matrix of values and a second matrix of values, the first matrix of values representing a covariance of the first set of BEV features and the second set of BEV features, the second matrix of values representing a covariance of the third set of BEV features and the fourth set of BEV features of the training data.

15. The apparatus of claim 14, wherein the training data comprises a first domain descriptor value associated with the image sensor and a second domain descriptor value associated with the first non-image sensor, and wherein the third information comprises:
a second indication of a difference between the first domain descriptor value and a third domain descriptor value associated with a first BEV feature of the first set of BEV features, and
a third indication of a difference between the second domain descriptor value and a fourth domain descriptor value associated with a second BEV features of the second set of BEV features.

16. The apparatus of claim 15, wherein the differences between the BEV features of the training data and the first set of BEV features and the second set of BEV features are indicative of covariate shift between the first set of BEV features and the third set of BEV features, between the second BEV features and the fourth set of BEV features, or both.

17. A method of training a model for multi-sensor fusion, comprising:
receiving first information indicative of a first set BEV features of image data;
receiving second information indicative of a second set of BEV features of non-image sensor data;
determining third information indicative of differences between a third set of BEV features and a fourth set of BEV features, the third set of BEV features comprises a first plurality of BEV features of the first set of BEV features and a second plurality of BEV features of the second set of BEV features, the fourth set of BEV features comprises a third plurality of BEV features of the first set of BEV features and a fourth plurality of BEV features of the second set of BEV features; and
determining fused data that combines the image data and the non-image sensor data based on the first information, the second information, and the third information.

18. The method of claim 17, wherein the non-image sensor data is captured by either a LiDAR sensor or a RADAR sensor.

19. The method of claim 17, wherein determining the third information comprises determining a matrix of values representing a covariance of a plurality of pairs of BEV features,
wherein each pair of the plurality of pairs includes a first BEV feature of the first set of BEV features and a second BEV feature of the second set of BEV features, and
wherein the third information is based on the matrix of values.

20. The method of claim 19, wherein determining the third information comprises:
determining a first plurality of domain descriptors associated with the third set of BEV features;
determining a second plurality of domain descriptors associated with the fourth set of BEV features; and
determining indications of differences between the first plurality of domain descriptors and the second plurality of domain descriptors, wherein the third information is based on the indications of differences.

21. The method of claim 20, wherein determining the third information comprises:
determining a first set of samples that include a fifth set of BEV features of the fourth set of BEV features, wherein each BEV feature of the fifth set of BEV features is associated with an indication of the indications of differences that fails to meet a first threshold; and
determining a second set of samples that include a sixth set of BEV features of the fourth set of BEV features, wherein each BEV feature of the sixth set of BEV features is associated with an indication of the indications of differences that meets a second threshold,
wherein the second threshold is greater than the first threshold, and
wherein determining the fused data is based on the first set of samples and the second set of samples.

22. The method of claim 17, further comprising:
receiving fourth information indicative of a fifth set of BEV features of second non-image sensor data, wherein:
the third set of BEV features comprises the first plurality of BEV features of the first set of BEV features, the second plurality of BEV features of the second set of BEV features, and a fifth plurality of BEV features of the fifth set of BEV features,
the fourth set of BEV features comprises the third plurality of BEV features of the first set of BEV features, the fourth plurality of BEV features of the second set of BEV features, and a sixth plurality of BEV features of the fifth set of BEV features, and
the fused data combines the image data, the non-image sensor data, and the second non-image sensor data based on the first information, the second information, the third information, and the fourth information.

23. The method of claim 22, wherein the image data is captured by an image sensor of a camera, the non-image sensor data is captured by a LiDAR sensor, and the second non-image sensor data is captured by a RADAR sensor.

24. An apparatus comprising:
a memory storing processor-readable code; and
at least one processor coupled to the memory, the at least one processor configured to execute the processor-readable code to cause the at least one processor to perform operations including:
receiving first information indicative of a first set BEV features of image data;
receiving second information indicative of a second set of BEV features of non-image sensor data;
determining third information indicative of differences between a third set of BEV features and a fourth set of BEV features, the third set of BEV features comprises a first plurality of BEV features of the first set of BEV features and a second plurality of BEV features of the second set of BEV features, the fourth set of BEV features comprises a third plurality of BEV features of the first set of BEV features and a fourth plurality of BEV features of the second set of BEV features; and
determining fused data that combines the image data and the non-image sensor data based on the first information, the second information, and the third information.

25. The apparatus of claim 24, wherein the non-image sensor data is captured by either a LiDAR sensor or a RADAR sensor.

26. The apparatus of claim 24, wherein determining the third information comprises determining a matrix of values representing a covariance of a plurality of pairs of BEV features,
wherein each pair of the plurality of pairs includes a first BEV feature of the first set of BEV features and a second BEV feature of the second set of BEV features, and
wherein the third information is based on the matrix of values.

27. The apparatus of claim 26, wherein determining the third information comprises:
determining a first plurality of domain descriptors associated with the third set of BEV features;
determining a second plurality of domain descriptors associated with the fourth set of BEV features; and
determining indications of differences between the first plurality of domain descriptors and the second plurality of domain descriptors, wherein the third information is based on the indications of differences.

28. The apparatus of claim 27, wherein determining the third information comprises:
determining a first set of samples that include a fifth set of BEV features of the fourth set of BEV features, wherein each BEV feature of the fifth set of BEV features is associated with an indication of the indications of differences that fails to meet a first threshold; and
determining a second set of samples that include a sixth set of BEV features of the fourth set of BEV features, wherein each BEV feature of the sixth set of BEV features is associated with an indication of the indications of differences that meets a second threshold,
wherein the second threshold is greater than the first threshold, and
wherein determining the fused data is based on the first set of samples and the second set of samples.

29. The apparatus of claim 24, wherein the operations further include:
receiving fourth information indicative of a fifth set of BEV features of second non-image sensor data, wherein:
the third set of BEV features comprises the first plurality of BEV features of the first set of BEV features, the second plurality of BEV features of the second set of BEV features, and a fifth plurality of BEV features of the fifth set of BEV features,
the fourth set of BEV features comprises the third plurality of BEV features of the first set of BEV features, the fourth plurality of BEV features of the second set of BEV features, and a sixth plurality of BEV features of the fifth set of BEV features, and
the fused data combines the image data, the non-image sensor data, and the second non-image sensor data based on the first information, the second information, the third information, and the fourth information.

30. The apparatus of claim 29, wherein the image data is captured by an image sensor of a camera, the non-image sensor data is captured by a LiDAR sensor, and the second non-image sensor data is captured by a RADAR sensor.
